(19) United States
(12) Patent Application Publication
(10) Pub. No.: US 2012/0069046 A1
(43) Pub. Date: Mar. 22, 2012

(54) SYSTEMS AND METHODS FOR DISPLAYING COMPUTER-GENERATED IMAGES ON A HEAD MOUNTED DEVICE

(75) Inventors: Loren W. Rapoport, Richardson, TX (US); Thomas E. Milson, McKinney, TX (US); Zachary M. Gaubert, Dallas, TX (US)

(73) Assignee: RAYTHEON COMPANY, Waltham, MA (US)

(21) Appl. No.: 12/888,110

(22) Filed: Sep. 22, 2010

(51) Int. Cl. G09G 5/02

(52) U.S. Cl. 345/592; 345/8

(57) ABSTRACT

Systems and methods for displaying computer-generated images on a head mounted device are provided. In some embodiments, a system for displaying computer-generated image is provided and may include transparent surface including a coating and a processor. The processor may be configured to receive a computer-generated image, determine the type of computer-generated image, vary a voltage applied to the coating of the transparent surface based on the determined type of computer-generated image, and display the received computer-generated image on the transparent surface.

### TECHNICAL FIELD

The present disclosure relates to computer-generated images (CGIs), and in particular, systems and methods for displaying CGIs on a head mounting gear.

### BACKGROUND

In military operation, a see-though or look-through device, coupled to the helmet of a soldier, is often used to display tactical images, directions, and other combat-related information. Current see-through or look-through devices, which include image display unit that may be mounted to headgear, employ a dam, cover, or plate that is placed in position over a optical component of the helmet. Once in position, a computer-generated image (CGI), sometimes referred to as a virtual image, can be displayed.

However, the dams, covers, and/or plates often time can substantially block the entire real-time view (e.g., the current viewable surroundings) of the user, which in some environments, poses dangers to the user. Additionally, the dams, covers or plates can be misplaced, lost, or damaged.

### SUMMARY

In accordance with one embodiment of the present disclosure, a system for displaying computer-generated image is provided. The system may include a transparent surface comprising a voltage-adjustable coating and a processor. The processor may be configured to receive a computer-generated image, determine the type of computer-generated image, vary a voltage applied to the voltage-adjustable coating of the transparent surface based on the determined type of computer-generated image, and display the received computer-generated image on the transparent surface.

In other embodiments, a method for displaying computer-generated image on a transparent surface is provided. The method may include steps for receiving the computer-generated image, determining the type of computer-generated image, varying a voltage applied to a voltage-adjustable coating of a transparent surface based on the determined type of computer-generated image, and displaying the received computer-generated image on the transparent surface.

In some embodiments, a computer-readable medium comprising computer-executable instructions is provided. The instructions, when executed by a processor, are configured to receive computer-generated image, determine the type of computer-generated image, vary a voltage applied to a voltage-adjustable coating of a transparent surface based on the determined type of computer-generated image, and display the received computer-generated image on the transparent surface.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIGS. 1A and 1B illustrate an example system for displaying a computer-generated image (CGI) on a transparent surface of a headgear, in accordance with certain embodiments of the present disclosure;

FIGS. 2A and 2B illustrate examples of a coating coupled to a transparent surface for controlling the amount of light that passes through the transparent surface, in accordance with certain embodiments of the present disclosure;

FIG. 3 illustrates a front view of a transparent surface, in accordance with certain embodiments of the present disclosure;

FIG. 4 illustrates a cut-away plan view of a headgear that includes a transparent surface, in accordance with certain embodiments of the present disclosure; and

FIG. 5 illustrates a method for displaying CGI on a transparent surface of a headgear, in accordance with certain embodiments of the present disclosure.

### DETAILED DESCRIPTION

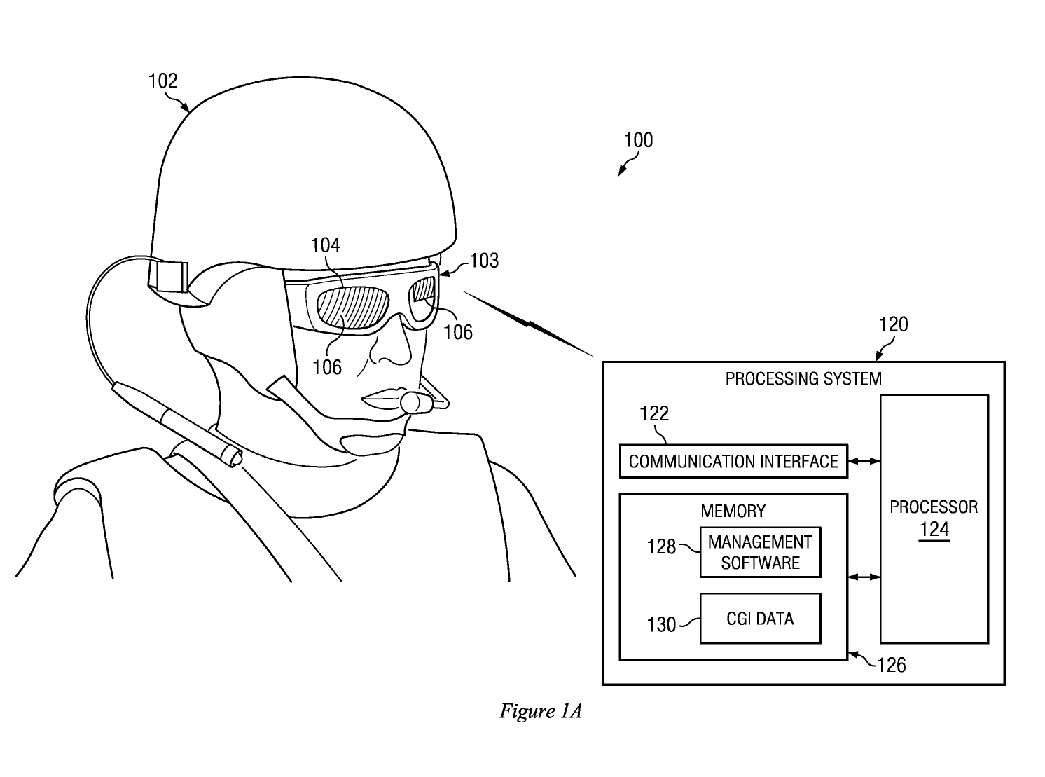

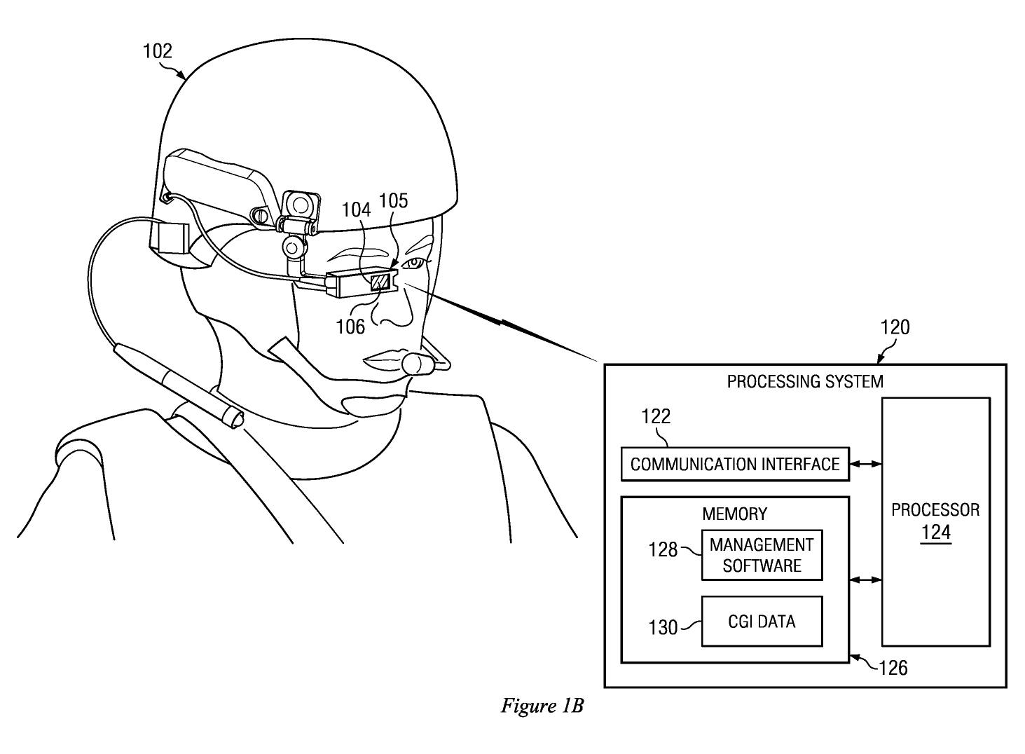

Preferred embodiments and their advantages are best understood by reference to FIGS. 1A through 5, wherein like numbers are used to indicate like and corresponding parts.

For purposes of this disclosure, a computer-generated image (CGI) may be an alphanumeric image, graphical image, and/or other types of images that may be presented and displayed to a user. In some embodiments, the CGI may include tactical intelligence images such as, for example, a map, a location of a target, thermal imaging data, and alphanumeric data (e.g., directives from mission control, coordinates, etc.).

FIGS. 1A and 1B illustrate an example system 100 for displaying a CGI 130, in accordance with certain embodiments of the present disclosure. It is noted that while FIGS. 1A and 1B show a military application of system 100, other applications are contemplated. For example, system 100 may be used by first responders, police departments, fire departments, SWAT teams, bomb squads, or other suitable type of users. System 100 may also be used in the medical field, where images from scans, X-rays, or other diagnostic equipment may be displayed to a doctor during surgery, evaluation of a patient, etc. System 100 may also be used for entertainment purposes, for example, for gaming or viewing sports.

Referring to FIG. 1A, system 100 may include headgear 102, optical component 103, transparent surface 104, and processing system 120. In some embodiments, headgear 102 may be various types of hats, helmets, head protection gear, visors, and/or other suitable head wear.

Optical component 103, integrally formed as a part of headgear 102 or secured to headgear 102, may be configured to display CGI 130. In some embodiments, optical component 103 may include optical components configured to receive CGI 130 from a processor, such as processor 124 of processing system 120, and project CGI 130 on transparent surface 104. In some embodiments, optical component 103 may include a mirror, a reflective surface, a prism, liquid crystal on silicon (LCos), light emitting diodes (LEDs), organic light emitting diodes (OLEDs), and/or other suitable electronically modulated optical elements configured for projecting CGI 130 on a display substrate such as, for example, transparent surface 104.

Transparent surface 104 may be substantially transparent, partially transparent, and/or transparent surface and configured to display a projected CGI 130 from optical component 103. In some embodiments, transparent surface 104 may be made of glass, polycarbonate, acrylic, Plexiglas, Lexan, and/or other suitable transparent materials. As shown in FIG. 1A, transparent surface 104 may be embodied in an eyewear, such as, for example, goggles, eyeglasses, or other suitable eye gear that is integrally formed with or coupled to headgear 102. In some embodiments, transparent surface 104 may be one or more lenses disposed in a protective eye gear that is coupled to headgear 102.

In other embodiments, transparent surface 104 may be embodied in a see-through display 105 that may be mounted or secured to headgear 102 for example, as shown in FIG. 1B. See-through display 105 may be positioned over a user's eye or eyes to see a projected CGI 130.

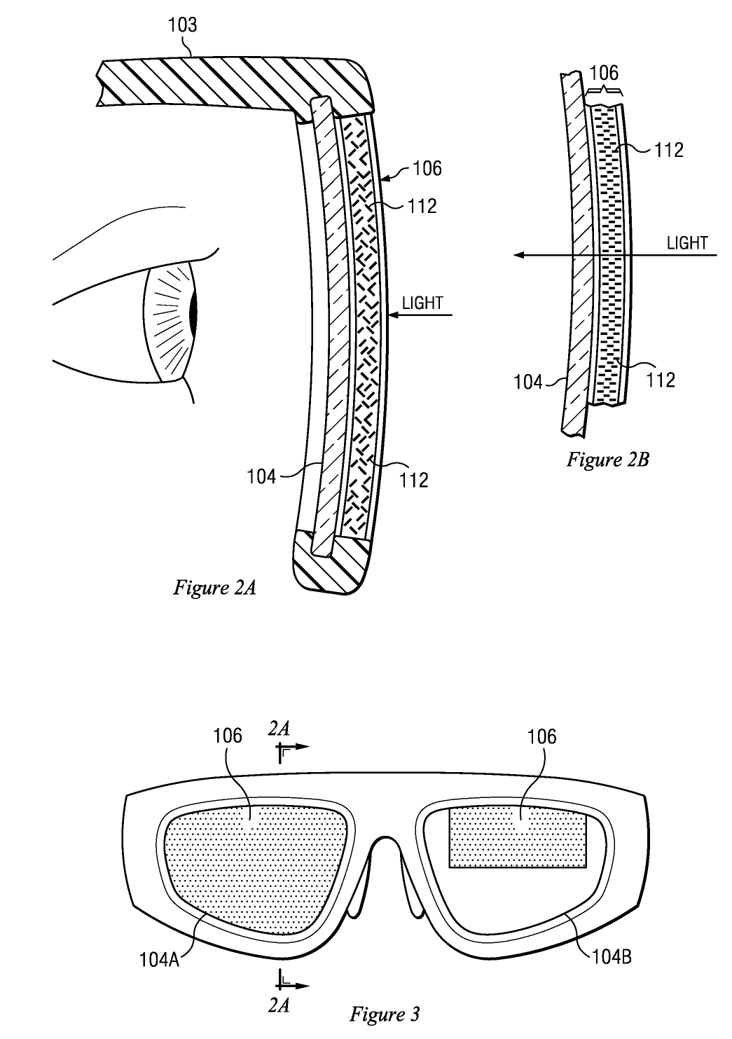

Transparent surface 104 may include a coating 106 applied to a portion of or to the entire surface of transparent surface 104, where coating 106 filters, restricts, or blocks the amount of light that passes through transparent surface 104. In some embodiments, coating 106 may be any suitable films or coatings and may include variable shading, variable tinting, or variable degrees of translucent. For example, coating 106 may be a suspended particle device (SPD) coating, an electrochromic (EC) coating, or other suitable film and/or coating configured to control the amount of light that passes through transparent surface 104. For example, referring to FIG. 2A, a cross-section of an SPD coating 106 applied to transparent surface 104 is shown. SPD coating 106 may include multiple particles 112 that may move based on voltage applied by, for example, a voltage regulator (e.g., variable voltage regulator 110 of FIG. 3) coupled to SPD coating 106. Referring to FIG. 2A, when no voltage is applied to coating 106, the particles 112 may be randomly positioned within coating 106, substantially blocking all light from passing through transparent surface 104. Referring to FIG. 2B, when a voltage is applied via, for example, a voltage regulator, particles 112 of coating 106 may realign to a normalized pattern, allowing light to pass through. Depending on the voltage applied to coating 106, about one percent (1%) to about ninety-nine percent (99%) of light may be allowed to pass through.

Referring again to FIGS. 1A and 1B, system 100 may include processing system 120 in communication with headgear 102. In some embodiments, processing system 120 may be a portable processing system and may include communication interface 122, processor 124, and memory 126. Communication interface 122 may include any system, device, or apparatus configured for wired and/or wireless communication with external devices, such as headgear 102, as well as various input and output (I/O) devices, for example a keyboard, a mouse, etc. In some embodiments, communication interface 122 may serve as an interface between processing system 120 and a network using any suitable transmission protocol and/or standard. For example, communication interface 122 may provide an interface between headgear 102 and processor 124, such that any received CGI 130 may be forwarded to processor 124 for processing and subsequent displayed on transparent surface 104.

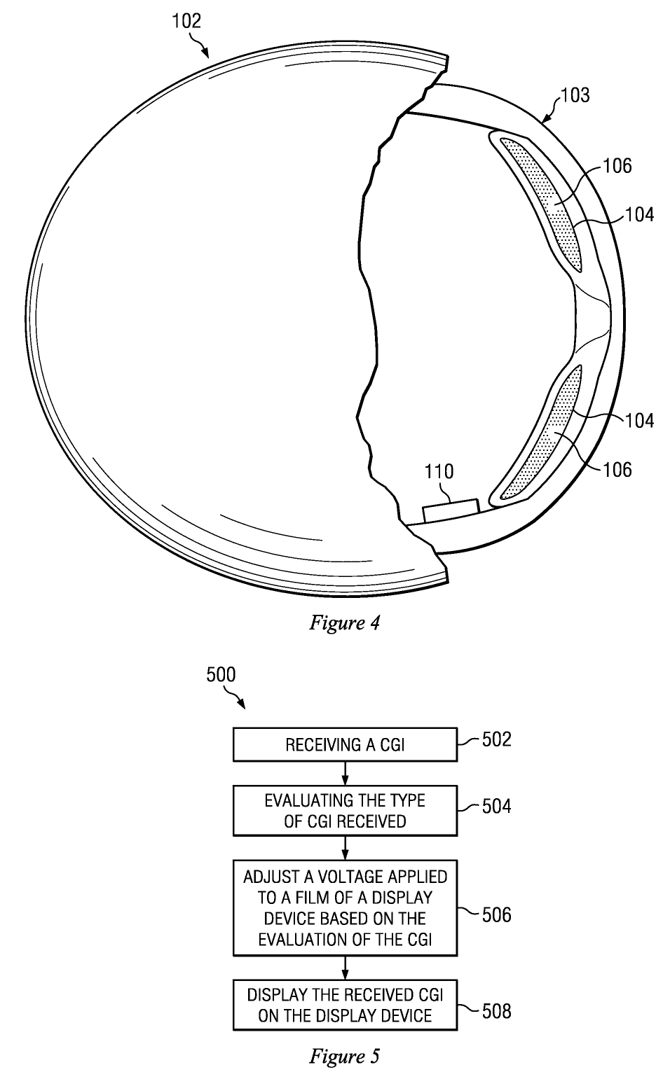

Processor 124, which may be communicatively coupled to optical component 103, transparent surface 104, and/or coating 106, may include any system, device, or apparatus operable to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 124 may receive CGI 130 from, for example, mission control, tactical team members, other personnel using a similar system, and/or other processors coupled to system 100 via communication interface 122 and may be configured to the change the properties of coating 106 based on the received CGI. For example, if CGI 130 includes fine details with complex graphical and/or alphanumerical data, processor 124 may alter the properties of coating 106 such that CGI 130 is presented at the best resolution to the user. In some embodiments, the processor 124 may alter a variable voltage regulator (e.g., variable voltage regulator 110 of FIG. 4) coupled to coating 106 via, for example, leads that may change the properties of coating 106.

In some embodiments, processor 124 may alter coating 106 based on a user's preference and/or the lighting conditions of the surrounding environment. For example, if a user prefers to see CGI 130 without viewing the current surrounding, processor 124 may alter the properties of coating 106 on transparent surface 104 to minimize or eliminate any light from passing through transparent surface 104. The user may provide the preferences via any suitable input device (e.g., keyboard, mouse, etc.) communicatively coupled to processing system 120, which may subsequently store the preference(s) in memory 126. Similarly, based on the lighting conditions of the surrounding environment (e.g., too dark or too light), processor 124 may alter the properties of coating 106 on transparent surface 104 to optimize the viewing of CGI 130 on transparent surface 104. For example, a light sensor communicatively coupled to processing system 120 may provided lighting condition information to processor 124. Processor 124 may adjust variable voltage regulator 110 such that the voltage applied coating 106 is adjusted to accommodate the current lighting condition surrounding the user. Next, processor 124, in communication with optical component 103 may project CGI 130 onto transparent surface 104 for viewing by a user. In some embodiments, processor 124 may subsequently store received CGI 130, a user's preference(s), and/or the settings of the variable voltage regulator in memory 126 for future use.

Memory 126 may be communicatively coupled to processor 124 and may include any system, device, or apparatus operable to retain program instructions (e.g., computer-readable media) or data for a period of time. Memory 126 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to system 100 is powered down or off. In some embodiments, memory 126 may store program instructions (e.g., management software 128), CGI 130, a user's preference, and/or other data.

Management software 128 may include a program of instructions that, when executed by a processor, e.g., processor 124, may manage the processing of CGI 130 received from a user, the adjusting of a variable voltage regulator, and/or the displaying of the CGI on transparent surface 104.

Referring to FIG. 3, a front view of transparent surface 104 is shown, in accordance with certain embodiments of the present disclosure. Transparent surfaces 104A and 104B may include coating 106 applied to a portion of transparent surfaces 104A and 104B using, for example, an adhesive. In some embodiments, coating 106 may be applied to an outer surface of transparent surfaces 104A and 104B, or the surface that is away from the user's eyes, although coating 106 may be applied on an inner surface (surface facing the user's eyes). As shown, coating 106 may be applied to the entire surface of transparent surface 104A and/or may be applied to a section of transparent surface 104B. In some embodiments, coating 106 may be applied to only transparent surface 104A or transparent surface 104B. In other embodiments, coating 106 may applied to a first section of transparent surface 104A and to a second section of transparent surface 104B, where the first section and second section are different. In some embodiments, the first section and the second section are in substantially the same area on transparent surface 104A and 104B. By positioning coating 106, the CGI displayed on optical component 103 may be allow for viewing of the surrounding environments, adjusting to the current lighting conditions, clearer viewing of the CGI information, etc., without using a dam or cover plate that can be easily lost or damaged.

In some embodiments, a variable voltage regulator 110 may be used to adjust the voltage applied to the coating 106, thereby controlling the amount of light that passes through transparent surface 104. Referring to FIG. 4, a cut-away plan view of headgear 102 is shown, in accordance with certain embodiments of the present disclosure. Variable voltage regulator 110, coupled to transparent surface 104, and specifically coating 106 via for example, leads or other suitable connectors and communicatively coupled to processing system 120, may be configured to apply a certain voltage to coating 106 adhered to transparent surface 104 based at least on CGI 130 to be displayed determined by processing system 120. For example, if the CGI includes small details, such as a map of an area, variable voltage regulator 110 may decrease or turn off the voltage applied to coating 106 such that light does not pass through the transparent surface. This may provide a dark background for CGI 130 to be displayed.

As another example, if CGI 130 includes minimal data, e.g., some alphanumeric data (e.g., directions, coordinates, etc.), variable voltage regulator 110 may increase the voltage applied to coating 106, allowing more light to pass through so that the user may receive CGI 130 as well as view the current, real-time surroundings.

In the same or alternative embodiments, voltage regulator 110 may be altered based on, for example, a user's preference and/or the lighting conditions of the environment. For example, if a user prefers to see all CGIs without seeing any of the current surroundings, the user may provide inputs via any suitable input device (e.g., keyboard, mouse, etc.) communicatively coupled to processing system 120, which may subsequently store the preference(s) in memory 126. Upon receiving CGI 130, processor 124 may retrieve the user's preference(s) from memory 126, decrease the variable voltage regulator 110, which limits the amount of light that passes through transparent surface 104, and may forward CGI 130 to display 103, which may project the received CGI 130 on transparent surface 104. As another example, if a user's current surrounding is too bright as detected by, for example, a light sensor communicatively coupled to processing system 120, processor 124 may adjust variable voltage regulator 110 such that the voltage applied coating 106 is decreased, limiting the light that passes through transparent surface 104.

FIG. 5 illustrates a method 500 for displaying CGI 130 on optical component 103 of headgear 102, in accordance with certain embodiments of the present disclosure. At step 502, CGI 130 may be received by processor 124. In some embodiments, CGI 130 may come from, for example, military officials at mission control providing tactical data for a user of headgear 102. The tactical data may include maps of the area, intended targets, the location of other unit members, the location of safe houses, the location of other personnel in the area, directions, coordinates, and/or other information or data. In some embodiments, CGI 130 may include alphanumeric data and/or graphical data.

At step 504, processor 124 may determine the type of CGI 130 received. For example, processor 124 may determine if received CGI 130 includes data that may be superimposed over the user's current real-time view or data that may need to obstruct the user's current real-time view.

At step 506, based on the determination made in step 504, processor 124 may adjust the voltage applied to coating 106 coupled to transparent surface 104 of optical component 103. In some embodiments, processor 124 may increase the voltage, allowing light to pass through one or both transparent surfaces 104. Alternatively, processor 124 may decrease or remove all voltages applied to coating 106, thereby substantially blocking any light from passing through one or both transparent surfaces 104.

At step 508, processor 124 in communication with optical component 104 may project CGI 130 on transparent surface 104 for the user to view. Processor 124 may send the received CGI 130 or retrieve CGI 130 from memory 126 to optical component 103, which may project CGI 130 on transparent surface 104. In some embodiments, CGI 130 may be overlaid over the current real-time view of the user. Variable voltage regulator 110 may be adjusted to allow some light through transparent surface 104 (in step 506) allowing the current surroundings to be seen in conjunction with the viewing of CGI 130 on transparent surface 104. Alternatively, CGI 130 may block the current real-time view of the user. Variable voltage regulator 110 may be adjusted to substantially block the viewing of the current surroundings of the user, allowing the details of CGI 130 to display on transparent surface 104.

For the purposes of this disclosure, computer-readable media may include any instrumentality or aggregation of instrumentalities that may retain data and/or instructions for a period of time. Computer-readable media (e.g., memory 126) may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory.

Although the present disclosure has been described in detail, it should be understood that various changes, substitutions, and alterations may be made hereto without departing from the spirit and the scope of the invention as defined by the appended claims.

What is claimed is:

1. A system for displaying computer-generated image, the system comprising:
a transparent surface, the transparent surface comprising a voltage-adjustable coating;
a processor configured to:
receive a computer-generated image;
determine the type of computer-generated image;
vary a voltage applied to the voltage-adjustable coating of the transparent surface based on the determined type of computer-generated image; and
display the received computer-generated image on the transparent surface.

2. The system according to claim 1, the voltage-adjustable coating comprising a suspended particle device coating or electrochromic coating.

3. The system according to claim 1, further comprising a variable voltage regulator electrically coupled to the voltage-adjustable coating, and wherein varying a voltage applied to the voltage-adjustable coating comprises adjusting the variable voltage regulator.

4. The system according to claim 1, wherein varying a voltage applied to the voltage-adjustable coating comprises decreasing the voltage applied to the voltage-adjustable coating to block light from passing through the transparent surface or increasing the voltage applied to the voltage-adjustable coating to allow more light to pass through the transparent surface.

5. The system according to claim 1, the system further comprising a headgear comprising the transparent surface.

6. The system according to claim 1, wherein the voltage-adjustable coating is applied to at least a portion of the transparent surface.

7. The system according to claim 1, wherein the computer-generated image comprises at least one of alphanumeric data and graphical data.

8. The system according to claim 1, wherein the processor is further configured to vary a voltage applied to the voltage-adjustable coating of the transparent surface based on at least one of a preference of a user and a lighting condition of the surrounding environment.

9. A method for displaying computer-generated image on a transparent surface, the method comprising:
receiving the computer-generated image;
determining the type of computer-generated image;
varying a voltage applied to a voltage-adjustable coating of a transparent surface based on the determined type of computer-generated image; and
displaying the received computer-generated image on the transparent surface.

10. The method according to claim 9, the voltage-adjustable coating comprising a suspended particle device coating or electrochromic coating.

11. The method according to claim 9, wherein varying a voltage applied to the voltage-adjustable coating comprises decreasing the voltage applied to the voltage-adjustable coating to block light from passing through the transparent surface or increasing the voltage applied to the voltage-adjustable coating to allow more light to pass through the transparent surface.

12. The method according to claim 9, wherein the computer-generated image comprises at least one of alphanumeric data and graphical data.

13. The method according to claim 9, wherein displaying the received computer-generated image on the optical component comprises displaying the received computer-generated image on a portion of the transparent surface.

14. The method according to claim 9, wherein varying a voltage applied to the voltage-adjustable coating of the transparent surface is further based on at least one of a preference of a user and lighting condition of the surrounding environment.

15. A computer-readable medium comprising computer-executable instructions, the instructions configured to, when executed by a processor:
receive a computer-generated image;
determine the type of computer-generated image;
vary a voltage applied to a voltage-adjustable coating of a transparent surface based on the determined type of computer-generated image; and
display the received computer-generated image on transparent surface.

16. The computer-readable medium of claim 15, wherein the voltage-adjustable coating comprising a suspended particle device coating or electrochromic coating.

17. The computer-readable medium of claim 15, wherein varying a voltage applied to the voltage-adjustable coating comprises adjusting a variable voltage regulator coupled to the transparent surface.

18. The computer-readable medium of claim 15, wherein varying a voltage applied to the voltage-adjustable coating comprises decreasing a voltage applied to the voltage-adjustable coating to block light from passing through the transparent surface or increasing a voltage applied to the voltage-adjustable coating to allow more light to pass through the transparent surface.

19. The computer-readable medium of claim 15, wherein the computer-generated image comprises at least one of alphanumeric data and graphical data.

20. The computer-readable medium of claim 15, wherein varying a voltage applied to the voltage-adjustable coating of the transparent surface is further based on at least one of a preference of a user and lighting condition of the surrounding environment.
